(19) United States
(12) Patent Application Publication
(10) Pub. No.: US 2012/0238253 A1
(43) Pub. Date: Sep. 20, 2012

(54) System for Distributing Individualized Audio Information Over a Network

(76) Inventor: Stephen A. Ray, Nashville, TN (US)

(21) Appl. No.: 13/234,981

(22) Filed: Sep. 16, 2011

Related U.S. Application Data
(60) Provisional application No. 61/383,765, filed on Sep. 17, 2010.

(51) Int. Cl. H04W 4/00

(52) U.S. Cl. 455/414.1

(57) ABSTRACT

A system for providing individualized information to a consumer over a network has been developed. The system includes a device, such as a sign, that identifies to a consumer a subject of interest. The device provides a unique identifying number associated with the subject that allows the consumer to access individualized information about the subject of interest through a website. The consumer sends the identifying number to the website with a mobile communications device and receives the information about the subject in the form of an audio file.

### CROSS-REFERENCE TO RELATED APPLICATIONS

This application claims priority from U.S. Provisional Patent Application No. 61/383,765 that was filed Sep. 17, 2010.

### FIELD OF THE INVENTION

The invention relates generally to system of distributing personalized information in an audio format over a network.

### SUMMARY OF THE INVENTION

In some aspects, the invention relates to a system for providing individualized information to a consumer over a network, comprising: a notification apparatus that identities a subject associated with individualized information to a consumer, where the notification apparatus also provides a unique identifying number associated with the subject of the individualized information; a system server that stores the individualized information from a provider of the information; and an Internet website that allows the consumer to access the individualized information upon receipt of a unique identifying number associated with the subject of the individualized information, wherein the consumer sends the unique identifying number to the website through a mobile telecommunications device.

In other aspects, the invention relates to a system for providing individualized information to a consumer over a network, comprising: means for a identifying a subject associated with individualized information to a consumer and providing a unique identifying number associated with the subject of the individualized information; means for storing the individualized information from a provider in an electronically accessible media; and means for allowing the consumer to access the individualized information upon receipt of a unique identifying number through a mobile telecommunications device.

Other aspects and advantages of the invention will be apparent from the following description and the appended claims.

### BRIEF DESCRIPTION OF DRAWINGS

It should be noted that identical features in different drawings are shown with the same reference numeral.

FIG. 1 shows a diagram of one embodiment of the present invention.

FIG. 2 shows diagram of the relationships of elements of the system in one embodiment of the present invention.

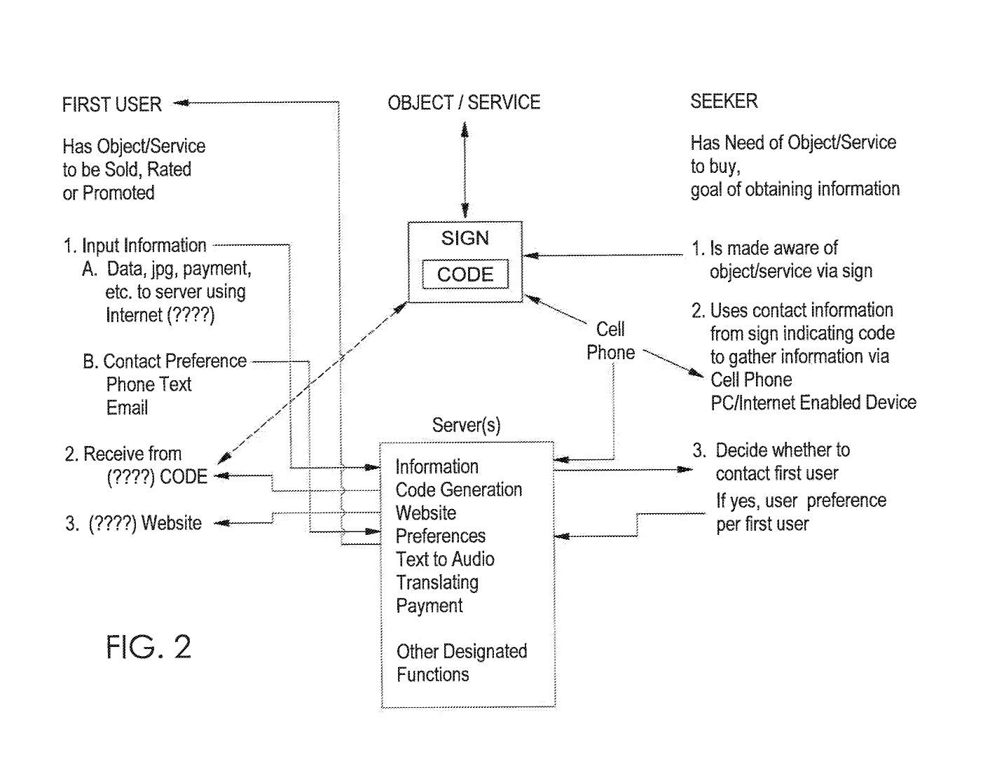

FIG. 3 shows an example of a sign used in one embodiment of the present invention.

### DETAILED DESCRIPTION

This application claims priority from U.S. Provisional Patent Application No. 61/383,765 and its contents are hereby incorporated by reference.

A system for distributing individualized audio files over a network has been developed. The system serves to link providers of information with consumers of information. These may also be known as sellers and buyers, givers and seekers, etc, depending on the context. The purpose of this system is to allow for the initial conveyance of information to be done using a simple cell phone or, and to further permit the use of more advanced devices such as smart phones, tablets, computers, etc.

The information being transferred typically revolves around a specific article or subject being promoted, whether a property, a vehicle, a service, or in the context of a social network, a particular person. The type and level of access to information that a provider permits the consumer to obtain may also vary. Providers may or may not permit direct phone contact, text message contact or email contact. They may or may not provide a physical point of contact: for a house or car (e.g. 123 Main Street) or a virtual contact such as a Web address.

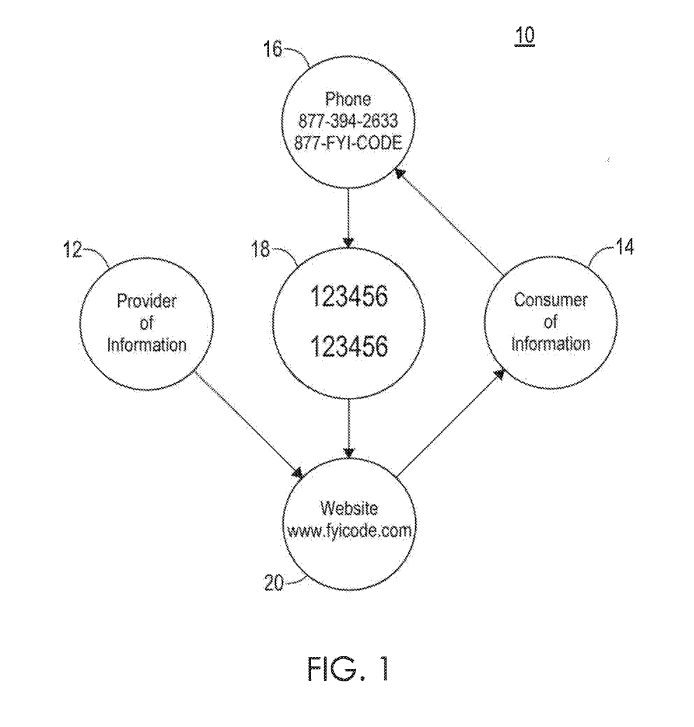

FIG. 1 shows a diagram of one embodiment of the present invention. In this example, the consumer 14 sees a form of notice indicating that information about the subject is available. For example, the notice may be a yard sign such as for a home for sale. The sign will provide a phone number for the consumer to call 16. Also, the sign will provide a unique identifying number 18 for the subject. Once connected to the system 10, the consumer will enter the identifying number 18 and unique information concerning the subject will be sent from the system's website 20 to the consumer 14 either as an audio file or text message link or audio file followed by the option of a text message link. The unique information will have been previously loaded on the system's website 20 by the provider of information 12.

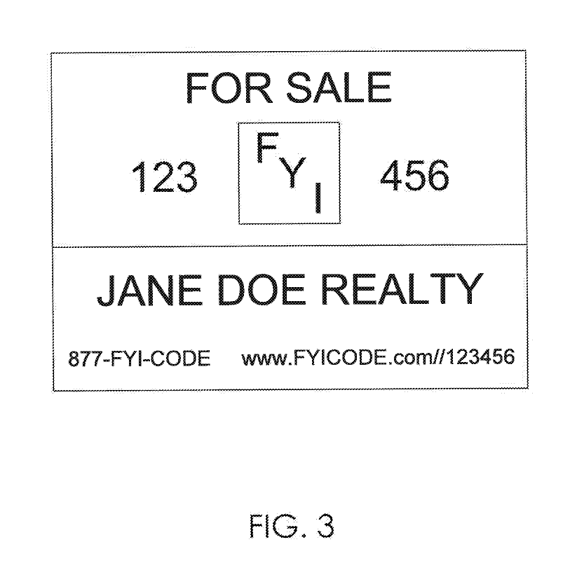

In alternative embodiments, notice and subject could vary widely. For example, the system could use a sign to provide notice of a garage sale. Also, it may use a billboard promoting a website or a soft drink. It may use a T-shirt promoting a person, a cause, or support for a team. It could he a bumper sticker, a car decal or printed in a magazine. FIG. 3 shows an example of a sign in one embodiment of the present invention.

It is envisioned that each person or business could have a unique number, that when used with this system would allow anyone to connect with the person or entity with that number anywhere in the world. A phone number based point of contact and a website base for the “code” number itself are the two major components that make this system both useful and operational. In the present system, for ease of memory retention, the unique identifying number uses only 6 digits for ease of memory retention. This is important because this system's main use will be from the comfort of an automobile. Note also the positioning of the digits in two groups of three separated by a space, making the digits easier to retain on the part of mobile viewer.

In the broader context though, this is the convergence of a business or person's telephonic identity, and, that of their web identity. This system, while not limited to any number, could easily use a twelve (or more) digit matrix to expand the number of users whether people or businesses. The present invention may have use not only in a business context but for social interaction as well. The core of the system is the unique identifying “code” number. Once an entity has a “code” number and others know what to do with it, information may flow between givers and those who seek it.

It should be understood that that the invention can be used in a social media context. Thus, if you were at a party, you could give someone your code number (perhaps on a card or worn on your nametag or garment of some sort) and others could call the code and find out certain information that you had predetermined to disclose. It is understood that an “app” could be used for retrieving this same information whether via a cell phone or other electronic device, such as a computer, reader of any sort, tablet, etc. In other embodiments, the code number could be retrieved by using an optical or electronic scanner.

The disclosure of information would he completely controlled by the owner of the number and would not require any action or pre-approval by the provider to create a social relationship. Examples of information from the provider include name or title. This could be the name of a person, object (car, house, boat,), type of service (sale, yard sale, for rent, open house, detour), place (such as an address), business (for profit, non profit,) institution (hospital, school or university) or intellectual subject such as a book, a piece of music or other performance, or a link to a website. The information may also include a contact name or title of person or entity that “owns” the particular number. Alternatively, the number could he a person or entity associated with the subject. For example, a car dealer might put out information on a vehicle and a consumer using a phone call to inquire about the vehicle will connect with a specific person about the vehicle or the next available representative. Additional examples of information from the provider include: a text message, a video file, pictures other audio files and all of the links thereto.

The information is stored on a system server and accessed by the consumer through the website once the unique identifying number is verified. The information is loaded onto the system's server when the provider initiates the use of the system. In some embodiments, the use of the system is on a subscription basis (typically for repeat providers with multiple listings, e.g. real estate agent with multiple listings) or on a fee basis (typically for one time users, e.g., an individual having a yard sale). Once the service is activated and the number is assigned, the provider will provide the information to be sent to the consumer upon request.

In another embodiment, the information from the provider will be in the form of an audio file. Additionally, the system may use voice activation for the entry of the unique number. This facilitates the easy use of the system by someone who is driving car, sees a sign of interest, and then dials the number and enters the unique identifying number. The information is the relayed to the consumer in the form of an audio message while they are still driving in their car. The audio file may be self recorded by the provider or may be automatically generated by the system. The information may also include the option of being “call forwarded” to a live person. The information may initiate a connection to the website of the provider either through the intermediary site of the system or directly via the provision of a text message link to caller generated by the provider through the system. Additionally, the system will have the capability for multilingual calls.

While the invention has been described with respect to a limited number of embodiments, those skilled in the art, having benefit of this disclosure, will appreciate that other embodiments can be devised which do not depart from the scope of the invention as disclosed here. Accordingly, the scope of the invention should be limited only by the attached claims.

What is claimed is:

1. A system for providing individualized information to a consumer over a network, comprising:
a notification apparatus that identifies a subject associated with individualized information to a consumer, where the notification apparatus also provides a unique identifying number associated with the subject of the individualized information;
a system server that stores the individualized information from a provider of the information; and
an internet website that allows the consumer to access the individualized information upon receipt of a unique identifying number associated with the subject of the individualized information, wherein the consumer sends the unique identifying number to the website through a mobile telecommunications device.

2. The system of claim 1, where the individualized information comprises an audio file.

3. The system of claim 1, where the individualized information comprises a video file.

4. The system of claim 1, where the individualized information comprises a text message.

5. The system of claim 1, where the individualized information comprises an photograph in electronic format.

6. The system of claim 1, where the notification apparatus comprises a yard sign.

7. The system of claim 1, where the notification apparatus comprises a highway billboard.

8. The system of claim 1, where the notification apparatus comprises a car bumper sticker.

9. The system of claim 1, where the notification apparatus comprises a body covering.

10. The system of claim 1, where the unique identifying number comprises six digits.

11. The system of claim 1, where the unique identifying number is received through voice activation.

12. The system of claim 1, where the subject associated with individualized information comprises real estate.

13. The system of claim 1, where the subject associated with individualized information comprises an automobile.

14. The system of claim 1, where the subject associated with individualized information comprises rental property.

15. The system of claim 1, where the subject associated with individualized information comprises professional services.

16. The system of claim 1, where the subject associated with individualized information comprises social information about the provider of the information.

17. The system of claim 15, where the unique identifying number associated permanently associated with the provider of the information.

18. The system of claim 1, where the mobile telecommunications device comprises an internet capable cell phone.

19. The system of claim 1, where the mobile telecommunications device comprises an internet capable wireless tablet.

20. The system of claim 1, where the mobile telecommunication device comprises a scanning device.

21. A system for providing individualized information to a consumer over a network, comprising:
means for a identifying a subject associated with individualized information to a consumer and providing a unique identifying number associated with the subject of the individualized information;
means for storing the individualized information from a provider in an electronically accessible media; and
means for allowing the consumer to access the individualized information upon receipt of a unique identifying number through a mobile telecommunications device.
